(19) United States
(12) Patent Application Publication
(10) Pub. No.: US 2007/0234309 A1
(43) Pub. Date: Oct. 4, 2007

(54) Centralized code coverage data collection

(75) Inventors: Brian D. Davia, Seattle, WA (US); Curtis D. Anderson, Kent, WA (US); Craig L. Fleischman, Medina, WA (US); Loren J. Merriman, Duvall, WA (US); Vikas Singh, Issaqiah, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/395,087

(22) Filed: Mar. 31, 2006

(51) Int. Cl. G06F 9/44

(52) U.S. Cl. 717/130

(57) ABSTRACT

Code coverage data may be provided. An instrumented image may be created comprising a binary executable software module that may be populated with coverage code injected into the binary executable software module. A request for the instrumented image may be received and the instrumented image may be provided based upon the received request. In addition, the code coverage data may be received from the instrumented image. The code coverage data produced by the instrumented image may be executed during a test of the binary executable software module. The coverage code may be configured to produce the code coverage data configured to indicate what code within the binary executable software module was used during the test. The code coverage data may be analyzed and the binary executable software module may be optimized based on the code coverage data.

### BACKGROUND

When developing software, programming modules may be tested during the development process. Such testing may produce code coverage data. Code coverage data may comprise metrics that may indicate what code pieces within a tested programming module have been executed during the programming module's test. The code coverage data may be useful in a number of ways, for example, for prioritizing testing efforts.

In some situations, conventional tools for producing code coverage data have much to be desired, for example, in usability. For example, with conventional system, a software module tester must use a conventional tool to alter the software module's binary code to cause the code to produce code coverage data. This often causes problems because the learning curve for using such conventional tools is generally quite steep. Furthermore, large software systems require large amounts of resources to prepare for code coverage collection.

Thus, the conventional strategy is to require the software module tester to build an altered version of the tested software module each time a software module is to be tested. This often causes problems because the conventional strategy does not provide a distributed system that allows testers to easily collect and analyze code coverage data. Furthermore, the conventional strategy causes problems because it does not allow testers to test software modules without having to build an altered version of the tested software module.

### SUMMARY

Code coverage data may be provided. This Summary is provided to introduce a selection of concepts in a simplified form that are further described below in the Detailed Description. This Summary is not intended to identify key features or essential features of the claimed subject matter. Nor is this Summary intended to be used to limit the scope of the claimed subject matter.

In accordance with one embodiment, a method for providing code coverage data may be provided. The method may comprise receiving an instrumented image from a central location. The instrumented image may comprise a binary executable software module that may be pre-populated with coverage code injected into the binary executable software module. The method may further comprise executing the instrumented image during a test of the binary executable software module. The coverage code may be configured to produce the code coverage data configured to indicate what code within the binary executable software module was used during the test.

According to another embodiment, a system for providing code coverage data may be provided. The system may comprise a memory storage and a processing unit coupled to the memory storage. The processing unit may be operative to create an instrumented image comprising a binary executable software module. The binary executable software module may be populated with coverage code injected into the binary executable software module. Furthermore, the processing unit may be operative to receive a request for the instrumented image and to provide the instrumented image based upon the received request. Moreover, the processing unit may be operative to receive, at a central database, the code coverage data from the instrumented image. The code coverage data may be produced by the instrumented image being executed during a test of the binary executable software module. The coverage code may be configured to produce the code coverage data configured to indicate what code within the binary executable software module was used during the test.

In accordance with yet another embodiment, a computer-readable medium is provided which stores a set of instructions which when executed performs a method for providing code coverage data. The method executed by the set of instructions may comprise creating an instrumented image comprising a binary executable software module that may be populated with coverage code injected into the binary executable software module. The set of instructions may further comprise receiving a request for the instrumented image and providing the instrumented image based upon the received request. In addition, the set of instructions may further comprise receiving the code coverage data from the instrumented image. The code coverage data produced by the instrumented image may be executed during a test of the binary executable software module. The coverage code may be configured to produce the code coverage data configured to indicate what code within the binary executable software module was used during the test.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a code coverage system;

FIG. 2 is a block diagram of the code coverage system of FIG. 1 in more detail;

FIG. 3 is a flow chart of a method for providing code coverage data;

FIG. 4 is screen shot of a main dialog window;

FIG. 5 is screen shot of a dialog window; and

FIG. 6 is screen shot of a save data dialog window.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Code coverage data may be provided. Consistent with embodiments of the present invention, testers may collect code coverage data. Code coverage data may comprise metrics that may allow testers, software engineers, or other users to view which code pieces have been executed during a tested software module's use and which pieces have not been executed.

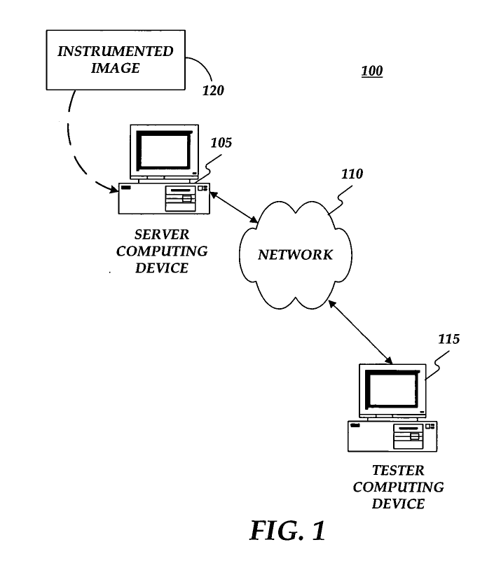

FIG. 1 is a block diagram of a code coverage system 100 consistent with an embodiment of the invention. System 100 may include a server computing device 105, a network, 110, and a tester computing device 115. Server computing device 105 may include an instrumented image 120. Instrumented image 120 may comprise a binary executable software module populated with coverage code. The coverage code may be injected into the binary executable software module on server computing device 105. For example, the binary executable software module may comprise a binary executable software module associated with an application program. Furthermore, the application program may be related to another application program within a suite. In addition, the binary executable software module may call or be called by the another binary executable software module within or without the suite. The another binary executable software module may also be injected with coverage code.

Consistent with embodiments of the invention, the binary executable software module may be updated. For example, new or improved versions of an application program may be developed. As these improvements are made, the binary executable software module associated with the improved version of the application program may be injected with coverage code. In this way, the most current version of binary executable software module may be pre-populated with coverage code and may be stored in a central location. Accordingly, a tester may have access to such a current pre-populated binary executable software module. Consequently, the tester may not need to injected with coverage code nor be concerned if the tester posses the most current version.

Server computing device 105 may receive a request for instrumented image 120 initiated by the tester from tester computing device 115 over network 110. Then, server computing device 105 may provide instrumented image 120 to tester computing device 115 based upon the received request. Once received, tester computing device 115 may execute the instrumented image during a test of the binary executable software module. The coverage code may be configured to produce the code coverage data configured to indicate what code within the binary executable software module was used during the test. After the test, server computing device 105 may receive, at a central database on server computing device 105, the code coverage data from the instrumented image. The code coverage may be analyzed, for example, to optimize the binary executable software module.

Network 120 may comprise, for example, a local area network (LAN) or a wide area network (WAN). When a LAN is used as network 120, a network interface located at any of computing devices 105 and 115 may be used to interconnect them. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. Computing devices 105 and 115 in the wireless environment can be any mobile terminal. Wireless data may include, but is not limited to, paging, text messaging, e-mail, Internet access, and other specialized data applications specifically excluding or including voice transmission. For example, computing devices 105 and 115 may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

An embodiment consistent with the invention may comprise a system for providing code coverage data. The system may comprise a memory storage and a processing unit coupled to the memory storage. The processing unit may be operative to receive an instrumented image from a central location. The instrumented image may comprise a binary executable software module that may be pre-populated with coverage code injected into the binary executable software module. Furthermore, the processing unit may be operative to execute the instrumented image during a test of the binary executable software module. The coverage code may be configured to produce the code coverage data configured to indicate what code within the binary executable software module was used during the test.

Another embodiment consistent with the invention may comprise another system for providing code coverage data. This system may comprise a memory storage and a processing unit coupled to the memory storage. The processing unit may be operative to create an instrumented image comprising a binary executable software module that may be populated with coverage code injected into the binary executable software module. Furthermore, the processing unit may be operative to receive a request for the instrumented image and to provide the instrumented image based upon the received request. The processing unit, however, does not need to be one single machine. For example, one server may store the instrumented images, another server may collect and store data, and an entire farm of machines may perform the actual image instrumentation. Moreover, the processing unit may be operative to receive, at a central database, the code coverage data from the instrumented image. The code coverage data may be produced by the instrumented image that may be executed during a test of the binary executable software module. The coverage code may be configured to produce the code coverage data configured to indicate what code within the binary executable software module was used during the test.

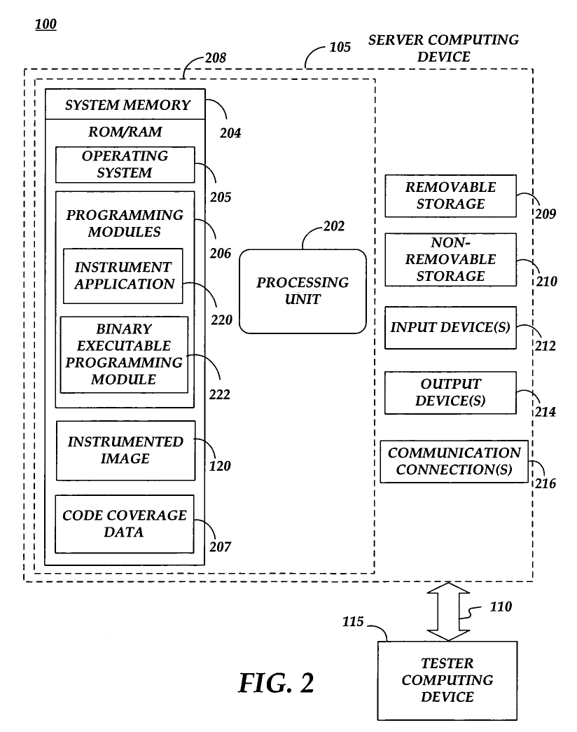

FIG. 2 is a block diagram of a system including server computing device 105. Consistent with an embodiment of the invention, the aforementioned memory storage and processing unit may be implemented in a computing device, such as server computing device 105 of FIG. 2. Any suitable combination of hardware, software, or firmware may be used to implement the memory storage and processing unit. For example, the memory storage and processing unit may be implemented with server computing device 105 or tester computing device 115, in combination with server computing device 105. The aforementioned system and device are examples and other systems, devices, and processors may comprise the aforementioned memory storage and processing unit, consistent with embodiments of the invention. Furthermore, server computing device 105 may comprise an operating environment for system 100 as described above. System 100 may operate in other environments and is not limited to server computing device 105.

With reference to FIG. 2, a system consistent with an embodiment of the invention may include a computing device, such as server computing device 105. In a basic configuration, server computing device 105 may include at least one processing unit 202 and a system memory 204. Depending on the configuration and type of computing device, system memory 204 may comprise, but is not limited to, volatile (e.g. random access memory (RAM)), non-volatile (e.g. read-only memory (ROM)), flash memory, or any combination. System memory 204 may include operating system 205, one or more software modules 206, instrumented image 120 and may include a code coverage data 207. Operating system 205, for example, is suitable for controlling server computing device 105's operation. In one embodiment, software modules 206 may include an instrument application 220 and a binary executable software module 222. Furthermore, embodiments of the invention may be practiced in conjunction with a graphics library, other operating systems, or any other application program and is not limited to any particular application or system. This basic configuration is illustrated in FIG. 2 by those components within a dashed line 208.

Server computing device 105 may have additional features or functionality. For example, server computing device 105 may also include additional data storage devices (removable and/or non-removable) such as, for example, magnetic disks, optical disks, or tape. Such additional storage may be illustrated in FIG. 2 by a removable storage 209 and a non-removable storage 210. Computer storage media may include volatile and nonvolatile, removable and non-removable media implemented in any method or technology for storage of information, such as computer readable instructions, data structures, program modules, or other data. System memory 204, removable storage 209, and non-removable storage 210 may comprise computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by server computing device 105. Any such computer storage media may be part of server computing device 105. Server computing device 105 may also have input device(s) 212 such as a keyboard, a mouse, a pen, a sound input device, and a touch input device, for example. Output device(s) 214 such as a display, speakers, a printer, for example, may also be included. The aforementioned devices are examples and others may be used.

Server computing device 105 may also contain a communication connection 216 that may allow server computing device 105 to communicate with tester computing device 115, such as over network 120 in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, instrument application 220 may perform processes including, for example, one or more method 300's stages as described below. The aforementioned process is an example, and processing unit 202 may perform other processes. Other software modules that may be used in accordance with embodiments of the present invention may include electronic mail and contacts applications, word processing applications, spreadsheet applications, database applications, slide presentation applications, drawing or computer-aided application programs, etc.

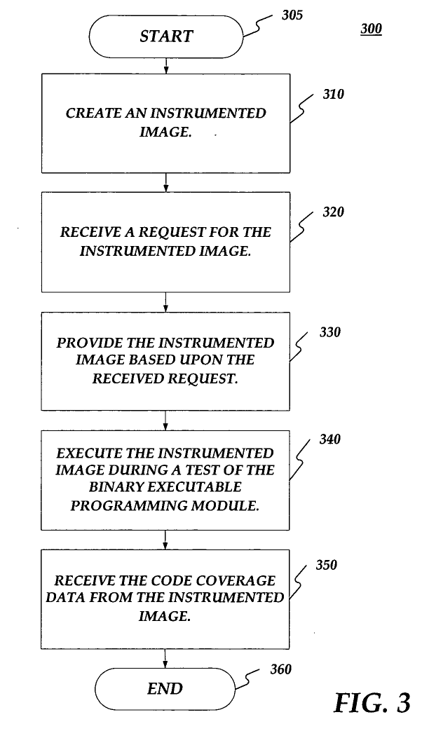

FIG. 3 is a flow chart setting forth the general stages involved in a method 300 consistent with an embodiment of the invention for providing code coverage data using system 100 of FIG. 1. Ways to implement the stages of method 300 will be described in greater detail below. Method 300 may begin at starting block 305 and proceed to stage 310 where server computing device 105 may create instrumented image 120. Instrumented image 120 may comprise binary executable software module 222 populated with coverage code injected into binary executable software module 222. Coverage code may comprise computer code that may cause, when injected into another program (e.g. binary executable software module 222) code coverage data to be produced. The produced code coverage data may indicate what code, of the program that the coverage code was injected into (e.g. software module 222), was executed. For example, executing on processing unit 202, instrument application 220 may inject the coverage code into binary executable software module 222. For example, binary executable software module 222 may comprise a binary executable software module associated with an application program. Furthermore, the application program may be associated with one or more other application programs within a suite. In addition, binary executable software module 222 may call or be called by the another associated binary executable software module within or without of the suite. The another associated binary executable software module may also be injected with coverage code by instrument application 220.

Furthermore, binary executable software module 222 may be updated periodically. For example, new or improved versions of an application program may be developed. As these improvements are made, the binary executable software module associated with the new or improved version of the application program may be injected with the coverage code. Accordingly, the binary executable software module associated with the new or improved version of the application program, injected with the coverage code, may replace binary executable software module 222. In this way the most current versions of binary executable software module 222 may be pre-populated with the coverage code and may be stored in a central location, for example, system memory 204.

From stage 310, where server computing device 105 creates instrumented image 120, method 300 may advance to stage 320 where server computing device 105 may receive a request for instrumented image 120. For example, the request may be received, for example, over network 120 from a tester operating tester computing device 115. Accordingly, the tester may have access to the most current pre-populated binary executable software module (e.g. instrumented image 120). Consequently, the tester does not need to injected coverage code, rather the tester can obtain the current pre-populated binary executable software module from server computing device 105. Furthermore, the tester does not need to be concerned as to whether the tester posses the most current version of binary executable software module on tester computer 115. The tester may know that server computing device has the most current instrumented image.

Once server computing device 105 receives the request for instrumented image 120 in stage 320, method 300 may continue to stage 330 where server computing device 105 may provide instrumented image 120 based upon the received request. For example, server computing device 105 may provide instrumented image 120 to computing device 115 over network 120. Instrumented image 120 may be installed, along with other associated instrumented images, using an install procedure that may be similar to installing executable software module 222 in its non-instrumented state.

From stage 330, where server computing device 105 provides instrumented image 120, method 300 may advance to stage 340 where tester computing device 115 may execute instrumented image 120 during a test of the binary executable software module 222. For example, the test may comprise causing binary executable software module 222 to open a file. The coverage code may be configured to produce the code coverage data configured to indicate what code within binary executable software module 222 was used or executed during the test. In this test example, the coverage code may produce the code coverage data indicating what code within binary executable software module 222 was executed during the file opening test.

After tester computing device 115 executes instrumented image 120 during the test of binary executable software module 222 in stage 340, method 300 may proceed to stage 350 where tester computing device 115 may receive the code coverage data from instrumented image 120 executed on tester computing device 115. The code coverage data may be sent from tester computer device 115 over network 120 to server computer device 105. For example, server computing device 105 may receive, at a central database on server computing device 105, code coverage data 207 from tester computing device 115. The central database, for example, may be pre-populated with module-specific information that may be required to store coverage data for that module. Code coverage data 207 may be analyzed, for example, to optimize binary executable software module 222. In other words, code coverage data 207 may be used, for example, to determine how to “tweak” binary executable software module 222 in order to optimize it or make it run faster. Furthermore, code coverage data 207 may be analyzed, for example, to prioritize test cases. For example, if a developer makes some changes to code, instead of running all test cases (most of which may be unrelated to the developer's code), embodiments of the invention may limit the test cases selected to only those that execute code that has been changed by the developer.

For example, code coverage data 207 may be used to optimize a “boot” scenario by seeing what code was touched during a “bleeding” of binary executable software module 222. From the code coverage data 207 produced in this example, when binary executable software module 222 is laid out in binary on a disk, for example, the code that is touched first in the binary may be laid out to where it may be loaded first and fastest. So instead of having to load binary executable software module 222 entirely before executing the boot, execution can start as soon as a first potion of binary executable software module 222 is loaded.

Consistent with embodiments of the invention, a code coverage tool for importing coverage data 207 to the central database may be provided. Though some coverage tools may be easy to use, others can be quite primitive. Learning how to use these primitive tools can be difficult. Consistent with embodiments of the invention, a graphical user interface (GUI) may wrap the difficulty of any underlying command-line code coverage tools. In addition to saving data and sending data to the central database, the code coverage tool may also provide easy access to tools for analyzing coverage data.

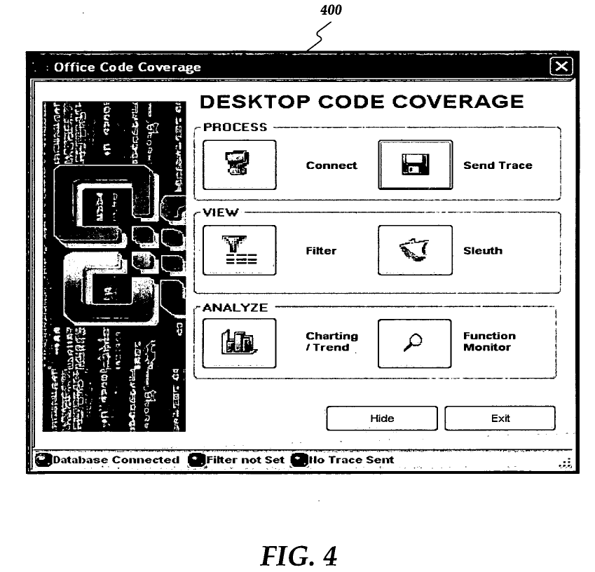

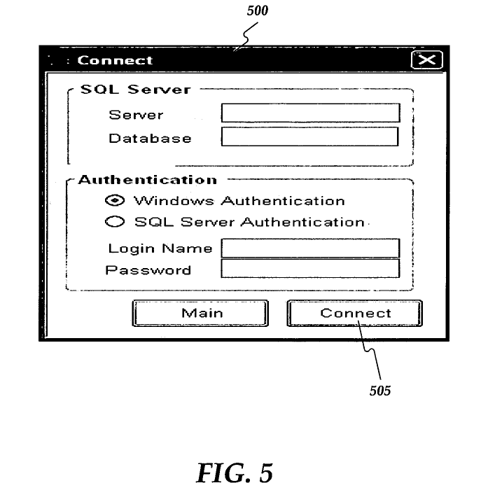

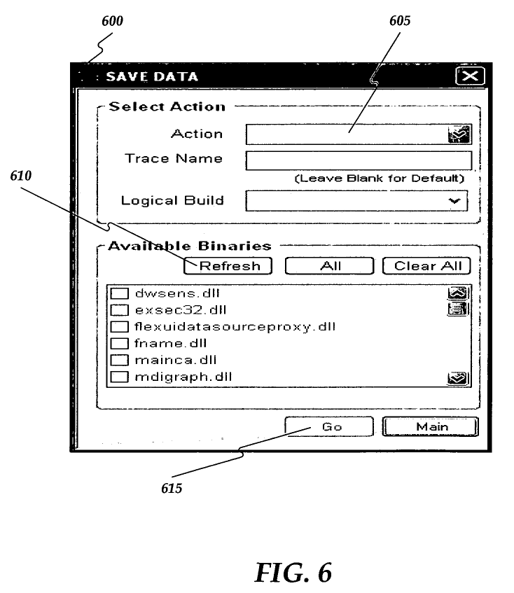

When the code coverage tool is booted, a main dialog window 400 as shown in FIG. 4 may be displayed on tester computer device 115 (shown below). Main dialog window 400 may be the root of all functionality of the code coverage tool. In order for data to be processed and viewed, the data may be imported to an internal code coverage toolset database. For example, a SQL server may be connected to and the database to work with may be specified. As shown in FIG. 5, a connection dialog window 500 may allow the user to specify the server and database to work with. The database may be an internal code coverage toolset database. The user may also have the ability to specify the type of authentication to use (e.g. Windows or SQL). Once a connect button 505 is clicked, the tool makes an attempt to connect to the database. If the database on the server does not yet exist, the tool may make an attempt at creating the database (user may need the appropriate credentials) and initialize it. Once a connection is established, the user may be notified. To disconnect from the database (which may be done before connecting to another) the user may press the disconnect button (e.g. shown when a connection is established.) The internal code coverage toolset, for example, may continuously collect data on all instrumented images running. In order to analyze the collected data, the data may first be saved and imported to the connected database. Saving and managing the data collected may be handled by a save data dialog window 600 as shown in FIG. 6. What this dialog does may be determined by what is selected in the action dropdown box 605.

As mentioned above, the internal code coverage toolset may continuously collect data on how instrumented images are being used, even when the code coverage tool is not running. This may mean that data is collected that is of no interest. To get rid of this data, a user may select “flush” in action dropdown box 605. For example, this may flush the memory of the internal code coverage toolset and allow data collection from a known origin.

Data collected by the internal code coverage toolset may be saved out in units of “traces.” A trace may comprise a collection of one or more test cases. When it comes time to analyze data collected, it may be useful if each test case (or scenario) is saved under a single scenario. Later, the user may be able to view results and filter data on the traces that generated it. There may comprise three trace-related actions in the save data dialog: save trace, send new trace, and send saved traces. The save trace action may allow the user to save a trace to a local machine (without sending it to the connected database). Note that the user may be able to save a trace without being connected to a database. To save a trace a user, for example, may:

1) Select the save trace action in dropdown box 605.

2) Specify a trace name. This may allow the user to later filter data based on traces that generated it.

3) Select the binaries for which you would like to save data in the available binaries list by checking the checkbox next to the binary names. If the binary interested in is not listed, then no data has been collected for that binary.

4) Click a go button 615 in window 600.

5) The user may be asked the location where the data should be saved. Specify the desired directory.

Traces may be saved in the form of .covdata files. There may be a single .covdata file for each binary selected in step 3 above. If there are already files located in the specified directory, the user may be asked if it is alright to merge the trace data into a single file for each binary selected. For example, if foo.dll.covdata already exists in the specified directory, and the user is saving another trace for foo.dll, it will merge the new and existing data into a single foo.dll.covdata file. The distinction between the existing trace(s) and the new trace may be retained in the merged file. If the user chooses not to merge the data, the user may be asked for another location to save the data.

The send saved traces action allows the user to send the saved traces (from section above) to a connected database. To send saved traces, for example, the user may:

1) Select the send saved traces action in dropdown box 605.

2) Specify a logical build. A logical build may be a way to group binaries (which may have different version numbers) into a single logical build. The existing logical builds of the connected database may be listed, but the user can specify a new logical build if you desire.

3) Click go button 615 in window 600.

4) When prompted, select one or more .covdata files to be imported into the connected database.

The data in the specified .covdata files may be imported to the connected database. The internal code coverage toolset may need static data from the original binaries from which traces are created. If the database has not yet been populated for a certain binary, the user may be asked to provide the original non-instrumented binary. If a trace exists in the connected database by the same name as one of the traces being imported, the user may be asked if the user would like to merge the traces. This may result in a union of the two traces. If the user chooses not to merge the trace, then none of the traces within the selected .covdata file will be imported.

The send new trace action may save data for the selected binaries and may send the saved data to the connected database without saving it locally. To send a new trace, for example, the user may:

1) Select the send new trace action in dropdown box 605.

2) Provide a trace name.

3) Select an existing logical build, or provide a name for a new logical build.

4) Select the binaries for which you would like to send data by checking the check box next to them in an available binaries list.

5) Click a go button 615 in window 600.

Once go button 615 is clicked, many of the same steps are taken to import data up to the database as the send saved traces action. In particular, if static data for a selected binary has not yet been imported to the database, the user may be asked for the original non-instrumented binary. Also, checks for existing traces with the supplied name may be checked.

The user may want to pre-populate the internal code coverage toolset database with static binary data before the user starts collecting coverage data. Or, the user may want to populate the database with static binary data for a binary which is not listed in the available binaries list. The import binary data action may allow the user to do this. For example, the user may:

1) Select the Import Binary Data action in the dropdown.

2) Click Go.,

3) When prompted, specify the .preop file of the binary you want to import.

4) When prompted, specify the corresponding original non-instrumented binary and the symbols file of the original non-instrumented binary.

The available binaries list may list all of the binaries for which the internal code coverage toolset has collected data. If the user have used a binary since the time the user opened a save data dialog and that binary does not appear in the list, the user may click refresh button 610 to update the list. Once server computing device 105 receives the code coverage data in stage 350, method 300 may then end at stage 360.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as show in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing code coverage data, the method comprising:
receiving an instrumented image from a central location, the instrumented image comprising a binary executable software module being pre-populated with coverage code injected into the binary executable software module; and
executing the instrumented image during a test of the binary executable software module, the coverage code configured to produce the code coverage data configured to indicate what code within the binary executable software module was used during the test.

2. The method of claim 1, wherein receiving the instrumented image further comprises receiving the instrumented image wherein the instrumented image is updated periodically with a current version of the binary executable software module.

3. The method of claim 1, wherein receiving the instrumented image comprising the binary executable software module further comprises receiving the instrumented image comprising the binary executable software module associated with at least one other binary executable software module wherein the binary executable software module and the at least one other binary executable software module are associated within a suite of application programs.

4. The method of claim 1, wherein executing the instrumented image during the test of the binary executable software module, the coverage code configured to produce the code coverage data configured to indicate what code within the binary executable software module was used during the test further comprises the coverage code configured to produce the code coverage data configured to indicate what code within another binary executable software module was used during the test, the another binary executable software module being called by the binary executable software module during the test.

5. The method of claim 1, further comprising transmitting the code coverage data to a central database using a desktop code coverage tool, the central database being pre-populated with binary data.

6. The method of claim 1, further comprising analyzing the code coverage data produced by the executed instrumented image using a desktop code coverage tool.

7. The method of claim 6, wherein analyzing the code coverage data further comprises using the code coverage data to optimize the binary executable software module.

8. A system for providing code coverage data, the system comprising:
a memory storage; and
a processing unit coupled to the memory storage, wherein the processing unit is operative to:
create an instrumented image comprising a binary executable software module being populated with coverage code injected into the binary executable software module;
receive a request for the instrumented image;
provide the instrumented image based upon the received request; and
receive, at a central database, the code coverage data from the instrumented image, the code coverage data produced by the instrumented image being executed during a test of the binary executable software module, the coverage code configured to produce the code coverage data configured to indicate what code within the binary executable software module was used during the test.

9. The system of claim 8, wherein the processing unit is further operative to update the instrumented image with a current version of the binary executable software module populated with coverage code injected into the current version of the binary executable software module.

10. The system of claim 8, wherein the processing unit being operative to create the instrumented image comprising the binary executable software module further comprises the processing unit being operative to create the instrumented image comprising the binary executable software module associated with at least one other binary executable software module wherein the binary executable software module and the at least one other binary executable software module are associated within a suite of application programs.

11. The system of claim 8, wherein the processing unit being operative to receive the code coverage data from the instrumented image, the coverage code configured to produce the code coverage data configured to indicate what code within the binary executable software module was used during the test further comprises the processing unit being operative to configure the coverage code to produce the code coverage data configured to indicate what code within another binary executable software module was used during the test, the another binary executable software module being called by the binary executable software module during the test.

12. The system of claim 8, wherein the processing unit is further operative to analyze the code coverage data produced by the executed instrumented image.

13. The system of claim 12, wherein the processing unit being operative to analyze the code coverage data further comprises the processing unit being further operative to use the code coverage data to optimize the binary executable software module.

14. A computer-readable medium which stores a set of instructions which when executed performs a method for providing code coverage data, the method executed by the set of instructions comprising:
creating an instrumented image comprising a binary executable software module being populated with coverage code injected into the binary executable software module;
receiving a request for the instrumented image;
providing the instrumented image based upon the received request; and
receiving the code coverage data from the instrumented image, the code coverage data produced by the instrumented image being executed during a test of the binary executable software module, the coverage code configured to produce the code coverage data configured to indicate what code within the binary executable software module was used during the test.

15. The computer-readable medium of claim 14, further comprising updating the instrumented image with a current version of the binary executable software module populated with coverage code injected into the current version of the binary executable software module.

16. The computer-readable medium of claim 14, wherein creating the instrumented image comprising the binary executable software module further comprises creating the instrumented image comprising the binary executable software module associated with at least one other binary executable software module wherein the binary executable software module and the at least one other binary executable software module are associated within a suite of application programs.

17. The computer-readable medium of claim 14, wherein receiving the code coverage data from the instrumented image, the coverage code configured to produce the code coverage data configured to indicate what code within the binary executable software module was used during the test further comprises the coverage code configured to produce the code coverage data configured to indicate what code within another binary executable software module was used during the test, the another binary executable software module being called by the binary executable software module during the test.

18. The computer-readable medium of claim 14, wherein receiving the code coverage data further comprises receiving the code coverage data at a central database.

19. The computer-readable medium of claim 14, further comprising analyzing the code coverage data produced by the executed instrumented image.

20. The computer-readable medium of claim 19, wherein analyzing the code coverage data further comprises using the code coverage data to optimize the binary executable software module.
